(19) United States
(12) Patent Application Publication
(10) Pub. No.: US 2008/0034495 A1
(43) Pub. Date: Feb. 14, 2008

(54) PATIENT GURNEY

(76) Inventors: Raymond E. Stidd, Bloomington, IN (US); Jan Gilbert, Muncie, IN (US); Edward Houghton-Ward, Banora Point (AU)

Correspondence Address: ANDERSON, LEVINE & LINTEL L.L.P., 14785 PRESTON ROAD, SUITE 650, DALLAS, TX, 75254, US

(21) Appl. No.: 11/620,934

(22) Filed: Jan. 8, 2007

Related U.S. Application Data
(60) Provisional application No. 60/774,940, filed on Feb. 17, 2006.
(60) Provisional application No. 60/807,544, filed on Jul. 17, 2006.
(60) Provisional application No. 60/756,760, filed on Jan. 6, 2006.

(51) Int. Cl. A61G 7/012

(52) U.S. Cl. 5/81.1 R

(57) ABSTRACT

A gurney is height adjustable with a locking mechanism to interact with other patient devices, such as patient beds and operating tables. The gurney one or more rotational and/or extending bed platforms to aid in the transfer of patients. Electronic controls are used to simplify operation of the gurney in transferring and transporting patients.

### CROSS-REFERENCE TO RELATED APPLICATIONS

This application claims the benefit of the filing date of copending provisional applications U.S. Ser. No. 60/756,760, filed Jan. 6, 2006, entitled “PATIENT GURNEY”, U.S. Ser. No. 60/774,940, filed Feb. 17, 2006, entitled “ROTATIONAL OPERATING TABLE” and U.S. Ser. No. 60/807,544, filed Jul. 17, 2006, entitled “ROTATIONAL OPERATING TABLE” which are incorporated by reference herein.

### STATEMENT OF FEDERALLY SPONSORED RESEARCH OR DEVELOPMENT

Not Applicable

### BACKGROUND OF THE INVENTION

1. Technical Field

This invention relates in general to hospital equipment and, more particularly, to a patient gurney for transporting patients.

2. Description of the Related Art

As part of hospital care, patients are transported frequently. If a patient is fairly ambulatory, transport may easily effected through the use of traditional devices, such as wheelchairs and gurneys, without the need for significant human resources. The transport of non-ambulatory patients (including patients who are physically impaired from a normal range of movement and patients who have been sedated or otherwise restricted in their movements), however, present many problems, as do morbidly obese patients. The growing number of obese patients by percentage in the United States population gives grave concern to physicians, administrative caregivers and nursing/auxiliary professional staff workers who are challenged on a daily basis with movement and transport of these patients as safely and as efficiently as possible.

A common problem involves the transfer of a patient from a non-transport device, such as a hospital bed, examination table or operating table, to a transport bed or “gurney” (or from the gurney to the non-transport device). The first problem is that multiple hospital personnel are needed to transfer the patient. The second problem is that the safety of the patient is of paramount importance and it is often critical that the transfer be made with minimum discomfort to the patient. In all cases, it is important that the patient be transferred without lodging between the gurney and non-transport device. The worst case scenario, where the patient falls to the floor while being transferred can cause significant liability to the hospital. A third problem is that moving patients, especially oversized patients, requires significant strength and is a source of injuries to hospital personnel. This also subjects the hospital to potential liability.

Another problem occurs in the actual transport of the patients on the gurney. This also requires multiple hospital personnel to guide a gurney for safe transport.

With hospitals attempting to minimize staffing, it becomes critical that hospital personnel are used efficiently. Since it is impractical to have staff that is solely dedicated to moving patients, the transport of patients often necessitates pulling staff away from other duties. Also, it is important that the workers health is not compromised.

Therefore, a need has arisen for a patient gurney that allows transfer and transport of patient with minimal human intervention and completes these tasks with maximum safety and injury prevention to both patient and hospital personnel.

### BRIEF SUMMARY OF THE INVENTION

In the present invention, a patient gurney for transferring patients to or from a patient supporting device, such as a patient bed, examination table or operating table, includes a moveable bed platform with a height adjustment mechanism for controlling the height of the bed platform. An attachment means coupling the gurney with the patient supporting device for maintaining the gurney and patient supporting device in a fixed relationship during transfer of the patient.

The present invention provides significant advantages over the prior art. First, a single staff member can transfer a patient from gurney to a patient supporting device without excessive stress to either the patient or the staff member. Second, the gurney can interact with existing hospital equipment with little or no modification. Third, transport and electronic control can be added to simply operation and handling of the gurney.

### BRIEF DESCRIPTION OF THE SEVERAL VIEWS OF THE DRAWINGS

For a more complete understanding of the present invention, and the advantages thereof, reference is now made to the following descriptions taken in conjunction with the accompanying drawings, in which:

FIG. 1a illustrates a front view of a patient gurney;

FIG. 1b illustrates a side view of a patient gurney;

FIG. 2 illustrates a patient gurney in position to receive a patient from a bed or operating table;

FIG. 3 illustrates a patient gurney transferring a patient to a bed or operating table using a tilting mechanism;

FIG. 4 illustrates a patient gurney transferring a patient to a bed or operating table using a sliding platform mechanism;

FIG. 5 illustrates a patient gurney with dual platforms for optionally extending to accommodate oversized patients;

FIG. 6 illustrates a locking mechanism that can be incorporated into a patient bed or operating table;

FIG. 7 illustrates a first embodiment of a belt locking mechanism;

FIG. 8 illustrates a second embodiment of a belt locking mechanism;

FIG. 9 illustrates an embodiment of a electromagnetic locking mechanism;

FIG. 10 illustrates an embodiment of a clamping locking mechanism;

FIG. 11 illustrates a transfer board that can be used in conjunction with the patient gurney, or can be incorporated into the patient gurney, to aid in transferring patients;

FIG. 12 illustrates seating that can be positioned in the back of the gurney for transporting patient relatives and hospital personnel;

FIG. 13 illustrates a patient gurney with an attachable transportation system.

### DETAILED DESCRIPTION OF THE INVENTION

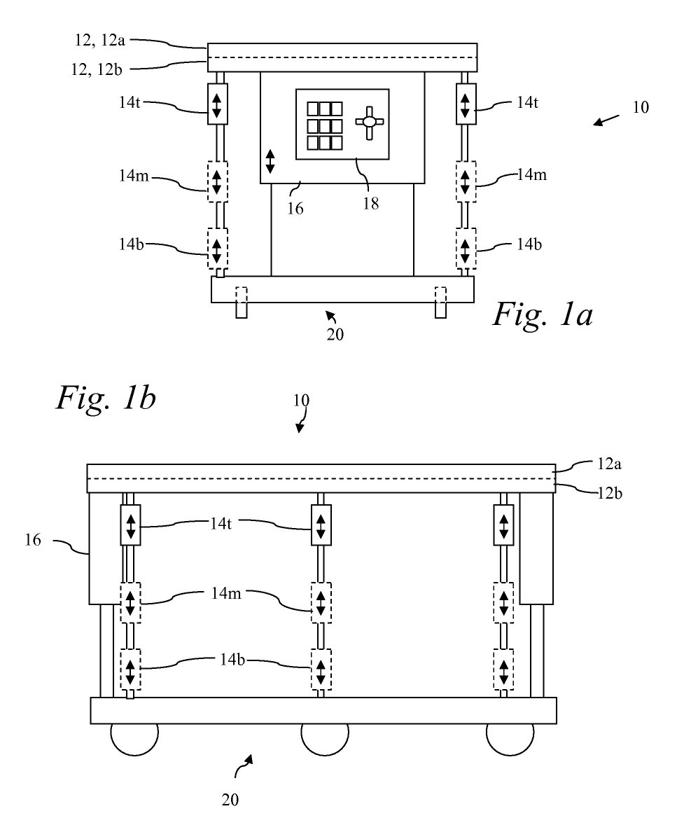

The present invention is best understood in relation to FIGS. 1-13 of the drawings, like numerals being used for like elements of the various drawings.

FIGS. 1a and 1b illustrate a front view and side view of a patient gurney, respectively. The gurney 10 includes one or more bed platforms 12 (individually referenced as bed platforms 12a and 12b) and one or more attachment points 14. In the illustrated embodiment, the gurney 10 has multiple attachment points 14 at multiple levels: top level attachment points 14t, mid-level attachment points 14m and bottom level attachment points 14b. In the preferred embodiment, the height of the attachment points 14 can be adjusted to accommodate a number of other devices such as patient beds and operating tables. To which the burney 10 can attach

The height of bed platforms 12 can be adjusted with vertical transport 16. A control panel 18 is used in the preferred embodiment to control a number of functions of the gurney: for example, bed platform height, control of bed platform angle and extension (described below), control of safety functions (such as guard rails—not shown), control of attachment point position, control of gurney movement in conjunction with gurney transport system 20. The control panel 18 allows a single hospital worker to control many functions of the gurney without help—however, a given implementation of the gurney could include some or all of these functions, as desired by the customer.

In operation, the patient gurney 10 is height adjustable to mate with other hospital devices which may be supporting non-ambulatory patients, such as patient beds, examination tables and operating tables, at a desired height for patient transfer. Attachment points 14 provide a secure connection between the gurney and the other device at the time of transfer to eliminate the possibility of a patient falling between the devices while being transferred. The bed platforms 12 aid in the transfer of a patient to reduce the number of hospital personnel needed to effect a transfer. The bed platforms can also be configured for other purposes, such as holding oversized patients. The transport system 20 allows a worker to effortlessly move patients within the hospital. A motorized transport system 20 may be integral to the gurney 10 or may be an attachment, such as shown in FIG. 13, which can be used in conjunction with multiple gurneys.

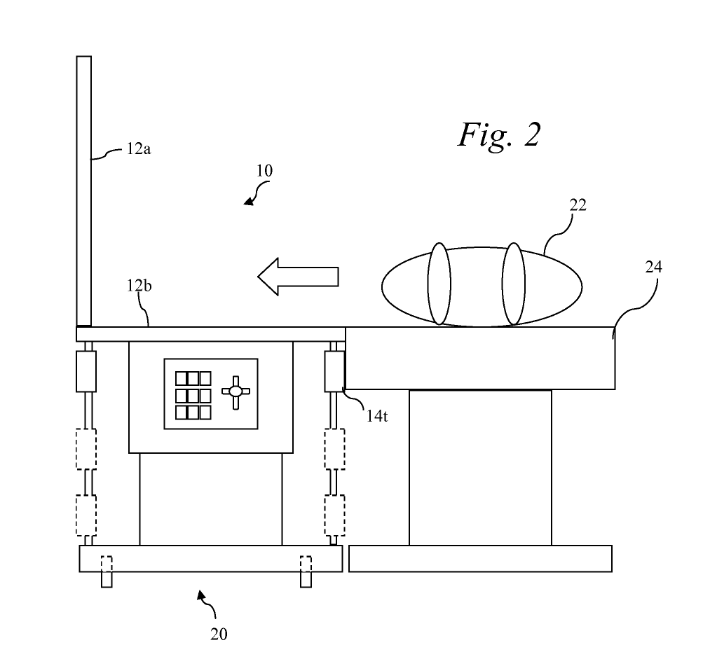

FIG. 2 illustrates a patient gurney 10 in position to receive a patient 22 from a bed or operating table 24. In this embodiment, bed platform 12a is positioned as a barrier to prevent the patient from falling off the opposite side of the gurney 10 during a transfer. A transfer board (see FIG. 11) may also be used to slide the patient onto the gurney. Attachment points 14t secure the gurney 10 to the other device 24 during the transfer. In the preferred embodiment, bed platform 12a is returned to a storage position at the side of the gurney or under bed platform 12b after the transfer is made. Guard rails (not shown) would also secure the patient in the gurney after the transfer and additional safety measures, such as retaining straps, could be used to hold the patient on the gurney 10.

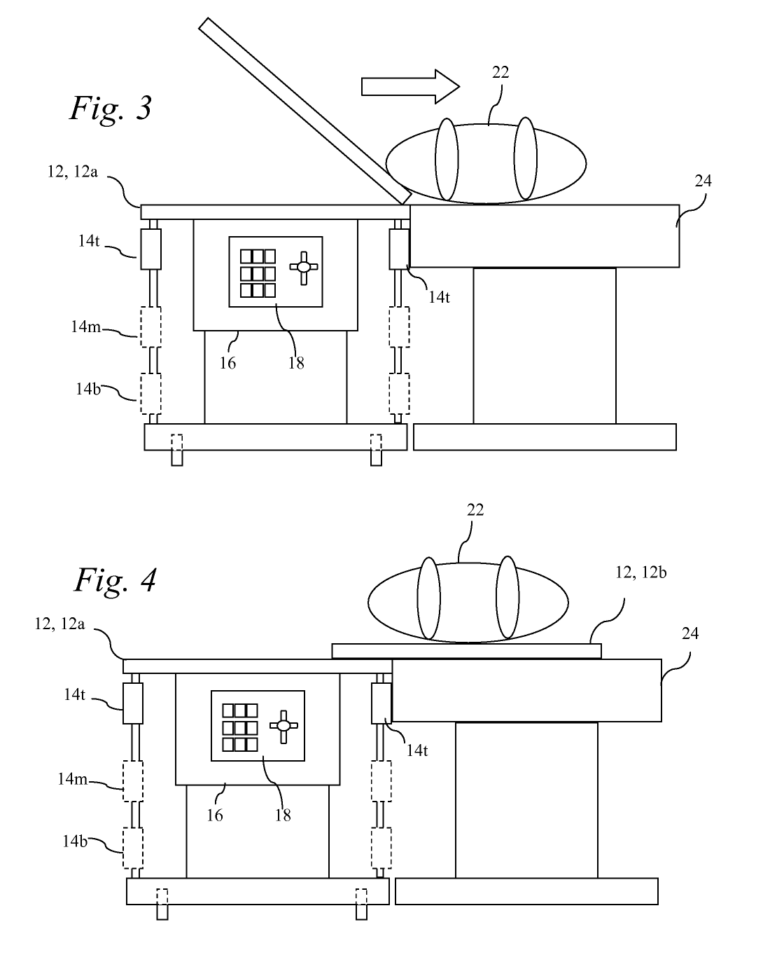

FIG. 3 illustrates a patient gurney transferring a patient 22 to a bed or operating table 24 using a tilting mechanism. In this embodiment, bed platform 12a rotates from a horizontal position to an angled position to use gravity to transfer the patient from the gurney 10 to the other device 24. A transfer board (see FIG. 11) may also be used to slide the patient onto the gurney. Attachment points 14t secure the gurney 10 to the other device 24 during the transfer. It should be noted that this could also be accomplished using a single bed platform 12 with rotational capabilities.

Rotation of one or both of the bed platforms 12 can be motorized or otherwise mechanically assisted. In a motorized version, the rotation is controlled by motors and control circuitry, similar to the rotating operating table described in U.S. application Ser. No. 11/620,549, filed Jan. 5, 2007, which is incorporated by reference herein. The rotation of the bed platforms could in a mechanically assisted version could be aided by mechanical cranks, levers and/or hydraulics to reduce the strength needed to rotate a bed platform supporting a patient.

FIG. 4 illustrates a patient gurney transferring a patient to a bed or operating table using a sliding platform mechanism. In this embodiment, bed platform 12a extends horizontally to a position above the top of the other device 24. A transfer board (see FIG. 11) may also be used to slide the patient onto the gurney. Attachment points 14t secure the gurney 10 to the other device 24 during the transfer. After the patient 22 is positioned over the other device, the patient can be held in place while the bed platform 12a is retracted. It should be noted that this could also be accomplished using a single bed platform 12 with extension capabilities. It should also be noted that the horizontal extension capabilities could be used to transfer the patient from the other device 24 to the gurney 10.

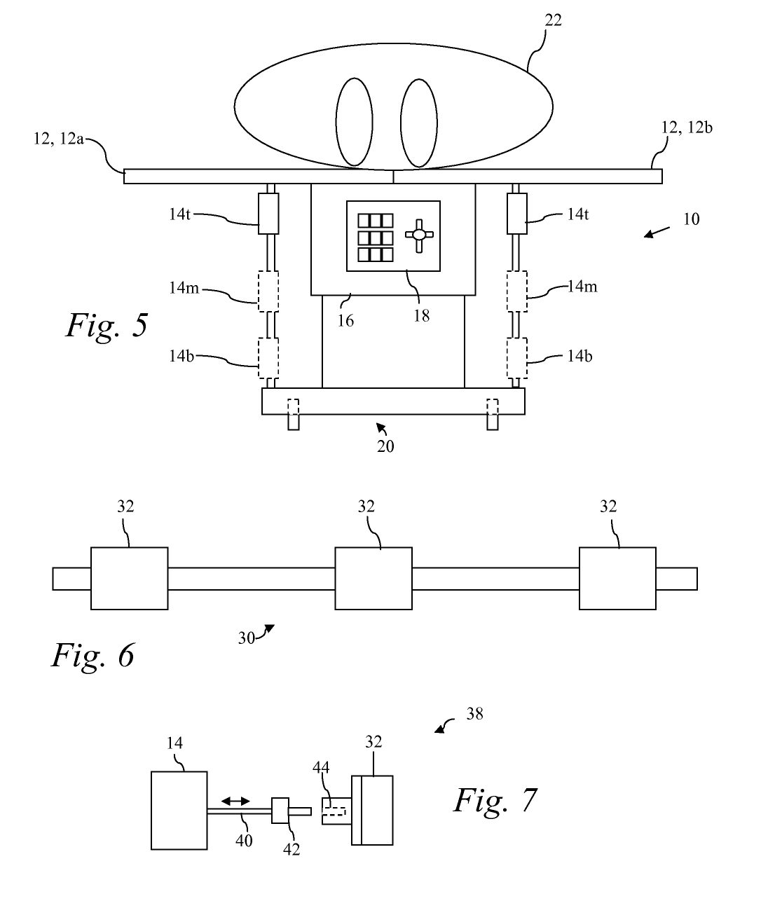

FIG. 5 illustrates a patient gurney with dual platforms for optionally extending to accommodate oversized patients. In this embodiment, the bed platforms 12a and 12b are positioned side by side to accommodate an oversized patient.

FIG. 6 illustrates a locking mechanism 30 that can be incorporated into a patient bed or operating table. It is anticipated that in the future, all devices for holding patients to be transferred, such as patient beds and operating tables, could incorporate an integrated locking mechanism for mating with attachment points 14. For existing equipment, it may be necessary to provide a locking mechanism that can be attached to the equipment, either through mechanical clamps or by other attachment procedures, such as welding to the equipment frame. Locking mechanism 30 includes attachment points 32 to mate with attachment points 14 on gurney 10.

FIG. 7 illustrates a first embodiment of a belt locking mechanism 38 to attach the gurney 10 to another device. In this embodiment, the locking mechanism is similar to a seat belt buckle as used in automotive applications. Attachment point 14 includes a belt 40 with male buckle part 42 and attachment point 32 includes a female buckle part 44 (the male and female parts could be switched on the attachment points. Once the buckle is engaged (male part secured in female part), the belt 40 is retracted, either automatically through the control panel or manual by friction, to hold the gurney tightly against the other device 24. In the preferred embodiment, the parts of the locking mechanism can be rotated so that they to not extend outwardly from the gurney or other device while not engaged.

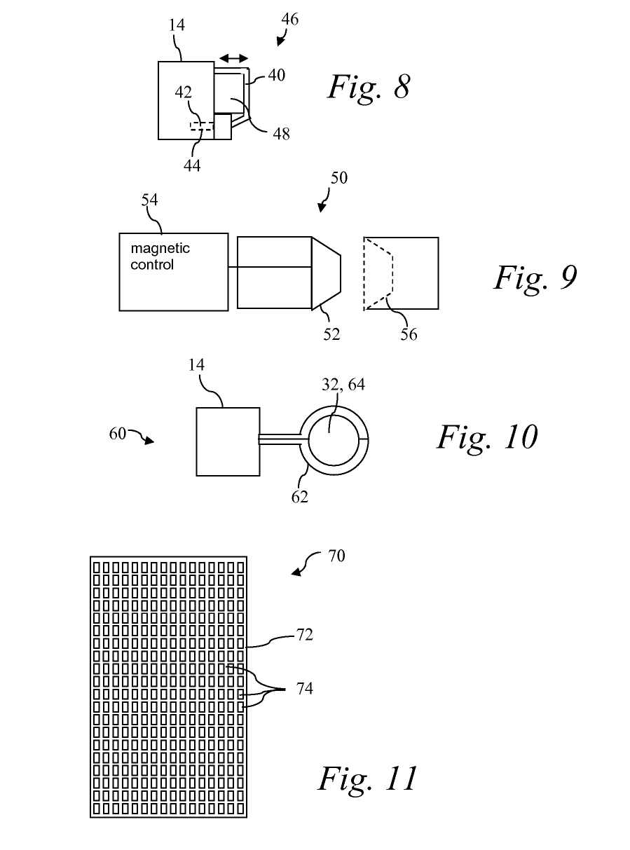

FIG. 8 illustrates a second embodiment of a belt locking mechanism 46, where attachment points 32 on the other device 24 are not needed. In this embodiment, the locking mechanism is again similar to a seat belt buckle, with the attachment point 14 including both the male part 42 and female part 44 of the belt buckle. The belt 40 is wrapped around the frame 48 of the other device (or to an attached bar) and returned to the attachment point 14. Once engaged, the belt is retracted, either automatically through the control panel or manual by friction, to hold the gurney tightly against the other device 24.

FIG. 9 illustrates an embodiment of a electromagnetic locking mechanism. In this embodiment, a magnet 52, under control of magnetic control 54, is disposed on attachment point 14. Magnet 52 is inserted into magnetic receptacle 56. Once inserted, magnet 52 is activated, by applying electricity to the magnet 56, causing a secure attachment with receptacle 56. When no longer needed, the electricity to magnet 52 is removed, causing the attachment point to be released. It should be noted that electromagnetic shielding would be required in the attachment points 14 and 32 to prevent undesirable electromagnetic interference with other medical equipment.

FIG. 10 illustrates an embodiment of a clamping locking mechanism 60. In this embodiment, a mechanical clamp 62 in attachment point 14 is engaged about a corresponding member 64 on attachment point 32, mechanically holding the gurney 10 to the other device 24. Any number of different configurations could be used to implement the mechanical clamp, as would be known to one skilled in the art.

FIG. 11 illustrates a transfer board 70 that can be used in conjunction with the patient gurney, or can be incorporated into the patient gurney, to aid in transferring patients. In the preferred embodiment, the transfer board uses a carbon fiber substrate 72 for light weight, with nylon wheels 74. In the preferred embodiment, the wheels 74 are extremely small and densely populated on the substrate to provide a superior sliding motion. for example, for a substrate 72 having dimensions of about six-to-seven feet length and sixteen to eighteen inches width, wheels 74 could be about ½ inch in diameter, or less, with approximately one inch spacing between rows and columns of wheels.

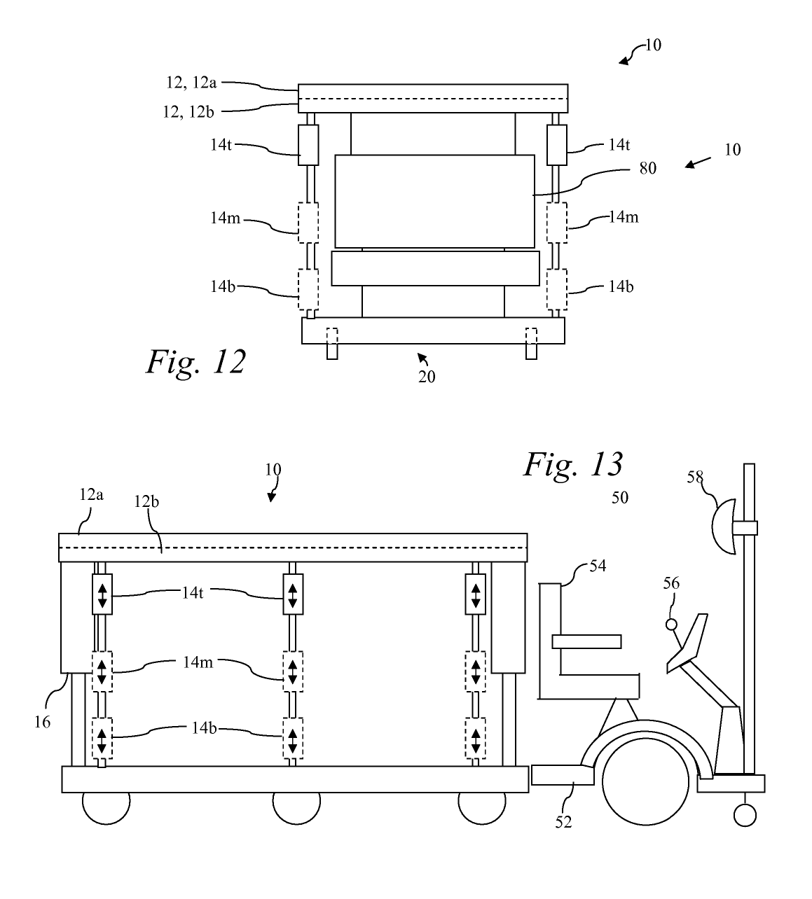

FIG. 12 illustrates seating 80 that can be positioned in the back of the gurney 10 for transporting patient relatives and hospital personnel. In this embodiment, a seat 80 is positioned at the back of the gurney 10 such that people in addition to the patient can be transported by the gurney 10. The seat 80 could also be positioned on the side of the gurney 10, and multiple seating could be accommodated on a single gurney.

The multiple bed platforms can also be used for turning a patient over, from a supine to prone position, or a prone to supine position. This aspect is discussed in U.S. application Ser. No. 11/620,549, entitled “Rotational Operating Table”, to Stidd et al, filed Jan. 5, 2007, reference above, which is incorporated by reference herein.

It should be noted that the various attachment points 14 and 32 described above could be used apart from the gurney 10 as shown to provide secure coupling between existing hospital devices, such as existing gurneys, operating tables and patient beds. In the preferred embodiment, the attachment point have some movement capability for greater flexibility in mounting the attachment points.

FIG. 13 illustrates an embodiment of the invention using a detachable transport system 50 to move the patient gurney (generally with a patient on the gurney). The transport system 50 includes a motorized transport mechanism 52, chair 54, steering 56 and a wide angle mirror 58.

The present invention provides significant advantages over the prior art. First, a single staff member can transfer a patient from gurney to a patient supporting device, such as patient bed, examination table or operating table, without excessive stress to either the patient or the staff member. Second, the gurney can interact with existing hospital equipment with little or no modification. Third, transport and electronic control can be added to simply operation and handling of the gurney.

Although the Detailed Description of the invention has been directed to certain exemplary embodiments, various modifications of these embodiments, as well as alternative embodiments, will be suggested to those skilled in the art. The invention encompasses any modifications or alternative embodiments that fall within the scope of the Claims.

What is claimed is:

1. A patient gurney for transferring patients to or from a patient supporting device comprising:
a moveable bed platform;
a height adjustment mechanism for controlling the height of the bed platform;
attachment means coupling the gurney with the patient supporting device for maintaining the gurney and patient supporting device in a fixed relationship during transfer of the patient.

2. The patient gurney of claim 1 wherein the moveable bed platform may be rotated about a horizontal axis.

3. The patient gurney of claim 1 wherein the moveable bed platform may be move in a horizontal plane.

4. The patient gurney of claim 1 wherein said first moveable bed platform comprises a first moveable bed platform and further comprising a second moveable bed platform.

5. The patient gurney of claim 4 wherein the moveable bed platforms can be aligned side by side.

6. The patient gurney of claim 4 wherein one of said bed platforms is removable.

7. The patient gurney of claim 1 wherein the attachment means includes one or more attachment points that are moveable.

8. The patient gurney of claim 1 wherein the attachment means includes one or more clamps.

9. The patient gurney of claim 1 wherein the attachment means includes one or more belts.

10. The patient gurney of claim 1 wherein the attachment means includes one or more magnets.

11. The patient gurney of claim 1 and further including a transfer board including a plurality of rollers.

12. The patient gurney of claim 11 wherein said rollers have a diameter of about ½ inch or less.

13. The patient gurney of claim 12 wherein said transfer board has a carbon fiber substrate.

14. The patient gurney of claim 1 and further comprising a motorized transport mechanism.

15. The patient gurney of claim 14 wherein said motorized transport mechanism is removable from the gurney.

16. The patient gurney of claim 1 and further comprising seating on the gurney for transporting people other than the patient.

17. The patient gurney of claim 1 wherein said patient supporting device to which the attachment means connects is one or more of an operating table, examination table or patient bed.
